(19) United States
(12) Patent Application Publication
(10) Pub. No.: US 2006/0032279 A1
(43) Pub. Date: Feb. 16, 2006

(54) Key assembly

(76) Inventor: Michael T. Andersen, Van Wert, OH (US)

Correspondence Address: Barnes & Thornburg LLP, 600 One Summit Square, Fort Wayne, IN, 46802, US

(21) Appl. No.: 10/915,859

(22) Filed: Aug. 11, 2004

(51) Int. Cl. E05B 19/00

(52) U.S. Cl. 70/395

(57) ABSTRACT

A key assembly includes a key, a cap and a fastener to selectively secure the cap to the key. The cap may include an opening for receiving a key ring, or other structure, therethrough. In one embodiment, the key includes a grip, and the cap and grip cooperate to enclose the key when the cap is secured in place.

### TECHNICAL FIELD

The present invention relates generally to key assemblies. More specifically, the invention relates to a key assembly, which includes a key and a cap secured to the key.

### BACKGROUND

Several devices have been developed for retaining or securing keys. Well known methods such as key rings have been apparent for some time. Some key rings include selective coupling with other rings, allowing a key(s) to be easily disconnected from a group of keys. Other key rings, however, require a more difficult disconnect process from the key ring.

### SUMMARY

The invention allows a key to be selectively fastened to a cap or other body. For example, in one illustrative embodiment the cap is secured to a key ring, thus allowing the key to be unfastened from the key ring and cap while in use. The key may then be again re-fastened to the cap and secured there until further use. In another illustrative embodiment of the key assembly, the key can include a grip for removing the key from the cap and for turning the key if needed. The cap and grip can be formed to enclose the key when the key is fastened to the cap.

In another illustrative embodiment, the cap and grip each include a magnet. The magnets interact, thereby fastening the cap and grip to one another. Alternatively, the key can be formed of ferromagnetic material to fasten the key to the cap. It is appreciated that other fastener-types may be used to fasten the cap to the key or grip, such as a clasp or leaf-spring, for example. The key and cap can be interlocking for fastening the key and cap to one another.

Additional embodiments, features and advantages will become apparent to those skilled in the art upon consideration of the following description of the illustrated embodiment exemplifying the best mode of carrying out the invention.

### BRIEF DESCRIPTION OF DRAWINGS

The present invention will be described hereafter with reference to the attached drawings which are given as non-limiting examples only, in which:

FIG. 1 illustratively shows a side view of a key assembly.

FIG. 2 illustratively shows another side view of the key assembly of FIG. 1.

FIG. 3 illustratively shows a front view of a cap and key of a key assembly.

Corresponding reference characters indicate corresponding parts throughout the several views. The exemplification set out herein illustrates embodiments of the key assembly, and such exemplification is not to be construed as limiting the scope of the key assembly in any manner.

### DETAILED DESCRIPTION OF THE DRAWINGS

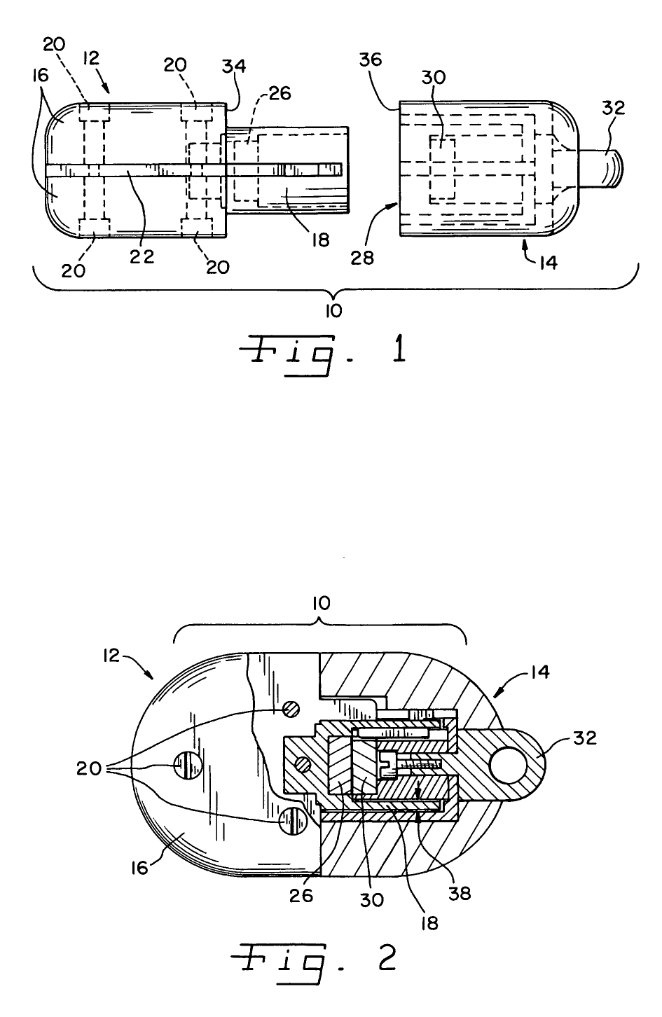

FIG. 1 is an illustrative side view of a key assembly 10 having a key 12 and a cap 14. Key 12 includes grip 16, key body 18, and key head 22 (shown in FIG. 3). Fasteners 20 fasten grip 16 to key head 22. Key body 18 is illustratively shown to have a circular cross-section, as shown in FIG. 3. It is appreciated that key body 18 may be formed in various shapes for various uses, such as automobile ignitions, for example. Key body 18 has magnet 26 located therein.

Cap 14 is illustratively shown to include opening 28, with magnet 30 located therein. Opening 28 is formed to receive key body 18. Opening 28 is also formed to allow magnets 26 and 30 to interact when key body 18 is disposed therein, bringing surfaces 34 and 36 into contact. Cap 14 includes ring 32. Ring 32 is formed to allow a key ring or other securing body to be disposed therethrough.

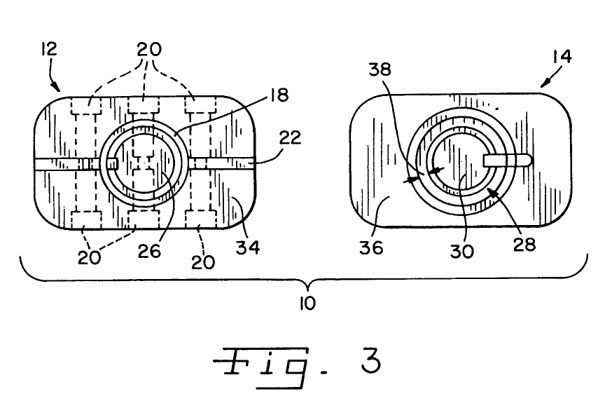

FIG. 2 is an illustrative side view of cap 14 and key 12 fastened to one another with surfaces 34 and 36 in contact with one another. Magnet 30 is formed to be received by key body 18 when key body 18 is received by opening 28. Magnets 26 and 30 are then able to interact with one another to selectively fasten key 12 to cap 14. Surfaces 34 and 36 have similar cross-sections and cap 14 and grip 16 are generally symmetrical. When cap 14 and key 12 are selectively fastened to one another, key assembly 10 is uniformly shaped. Cap 14 and key 12 enclose key body 18 when selectively fastened to one another, as illustratively shown in FIG. 2.

FIG. 3 illustratively shows a front view of both key 12 and cap 14. This view shows the circular cross-section of key body 18. Opening 28 is shown to be formed for receiving the circular cross-section of key body 18. Gap 38 is dimensioned to allow key body 18 to be received by opening 28 and allow magnet 30 to be received by key body 18. This allows magnets 26 and 30 to interact, thereby bringing surfaces 34 and 36 into contact.

Although the present invention has been described with reference to particular means, materials and embodiments, from the foregoing description, one skilled in the art can easily ascertain the essential characteristics of the present invention and various changes and modifications may be made to adapt the various uses and characteristics without departing from the spirit and scope of the present invention as set forth in the following claims.

1. A key assembly comprising:
a) a key having a longitudinal axis extending between first and second ends, said first end of the key comprising a grip and said second end of the key comprising a key body;
b) a cap having an opening to receive the second end of the key; and
c) a fastener to selectively secure the cap to at least one of the first and second ends.

2. The key assembly of claim 1, wherein the cap further comprises an opening for receiving a key ring therethrough.

3. The key assembly of claim 1, wherein the cap and grip are formed to enclose the key body when said cap is secured to one of the first and second ends.

4. (canceled)

5. The key assembly of claim 1, wherein the fastener comprises first and second magnets; and
wherein the cap has the first magnet disposed therein and the key has the second magnet disposed therein to selectively secure the cap to one of the first and second ends.

6. (canceled)

7. (canceled)

8. A key assembly comprising:
a) a key having a first portion which includes a grip, and a second portion which extends outwardly from the first portion;
b) a cap adapted to receive the second portion; and
c) means for selectively fastening the cap to the key.

9. The key assembly of claim 8, wherein the cap further comprises an opening adapted to receive the second portion of the key.

10. The key assembly of claim 8, wherein the cap and first portion are formed to enclose the second portion when said cap and key are selectively secured together.

11. A key assembly comprising:
a) a key body having a circular cross-section and a first magnet located therein;
b) a grip integrally formed with the key body, said key body extending outwardly therefrom; and
c) a cap having a first opening disposed therein and a second opening formed to receive the key body, said second opening having a second magnet disposed therein;
d) wherein, the cap and grip enclose the key body when said key body is received by the second opening, and wherein the cap and grip are fastened together through interaction of the first and second magnets.
